(19) United States
(12) Patent Application Publication
(10) Pub. No.: US 2006/0046766 A1
(43) Pub. Date: Mar. 2, 2006

(54) Method and system for bidirectional communications and power transmission

(75) Inventors: James M. Hair III, Cheyenne, WY (US); Daniel L. Greene, Cheyenne, WY (US)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: Abet Technologies, LLC, Evanston, IL (US)

(21) Appl. No.: 11/217,653

(22) Filed: Sep. 1, 2005

Related U.S. Application Data
(60) Provisional application No. 60/606,311, filed on Sep. 1, 2004.
(60) Provisional application No. 60/659,447, filed on Mar. 8, 2005.

(51) Int. Cl. H04B 7/00; H04Q 7/20

(52) U.S. Cl. 455/522

(57) ABSTRACT

A system for bidirectional data and power transmission are shown and described. In an embodiment, the system includes a network power controller that protects the network against over-current conditions by disconnecting system power when high current is detected at the power input. In an embodiment, power and data are transmitted between the network power controller and nodes on the network via a conduit having at least three wires. In an embodiment, an optical fiber is used to transmit data between the network power controller and the nodes. The use of a third wire or an optical fiber offers advantages over other systems for bidirectional data and power transmission in that they reduce the EMI effects on the system and allow for an increased duty cycle for power transmission.

### CROSS-REFERENCE TO RELATED PATENT APPLICATIONS

This patent application claims the benefit of U.S. Provisional Patent Application No. 60/606,311, filed Sep. 1, 2004, herein incorporated by reference in its entirety, and U.S. Provisional Patent Application No. 60/659,447, filed Mar. 8, 2005, herein incorporated by reference in its entirety.

### FIELD OF THE INVENTION

This invention pertains to methods and systems for distributing electrical power and data. In particular, the invention relates to a method and system for transmitting power and data using a single set of wires.

### BACKGROUND OF THE INVENTION

Microprocessors are found in almost every electronic device that we use in our day-to-day lives. One important application of microprocessors has been in the control of electronic devices installed in vehicles, including automobiles, buses, and airplanes. In the past, many critical automobile functions have been accomplished mechanically. Automobile functions such as wheel differential adjustments and engine timing are now controlled using sensors and actuators electrically connected to microprocessors.

Microprocessors provide well-known advantages, including making diagnostics and repairs easier in complicated machines. Microprocessors have also been used to improve the efficiency of machines when used with sensors and actuators in a feedback loop, thereby obtaining more efficient modes of operation. There are, however, some disadvantages to the use of microprocessors.

A look under the hood of a newer automobile may be enough to see one disadvantage to microprocessor use. Before microprocessors became small enough and reliable enough to be installed in automobiles, it was possible to see how separate engine parts were connected, and even to see the road underneath. Nowadays engine parts are covered by wires and cables that run from sensors and actuators attached to the mechanical parts to microprocessors used for control. Extra wires and cables are disadvantageous: every extra wire installed consumes power and adds weight. More wires also make maintenance harder.

Unfortunately, it has been largely impossible for wires to be eliminated from most microprocessor system designs. Conventionally, a separate wire has been required for power, ground, and each of a plurality of data transmission lines between a microprocessor and one or more sensors or actuators attached thereto.

U.S. Pat. No. 6,906,618, which was granted to the present inventors in 2005 and is herein incorporated by reference, discloses a method and system for bidirectional power and data transmission. The disclosed method and system reduce the number of wires used in power and data systems.

A continued need exists however for further improvements to conventional power and data systems.

### BRIEF SUMMARY OF THE INVENTION

In an embodiment, a network power controller in a system for bidirectional data and power transmission is provided. In an embodiment, the network power controller includes a power input for receiving positive power and negative power from a DC power source; a power output for transmitting power and data to nodes in the system; a short-circuit circuit protection circuit coupled to the power input and the power output; and a microcontroller for controlling the transmission of power and data to the system and for processing data sent and received by the network power controller. In an embodiment, the short-circuit protection circuit includes a short-circuit detection circuit coupled to the power input and a short-circuit switch coupled to the power output and controlled by the microcontroller.

In an embodiment of the present invention, the short-circuit detection circuit in the network power controller includes a current sensor for sensing the current on a power line and a current comparison circuit for determining whether the current is too high and providing feedback to the microcontroller. In an embodiment of the present invention, the current sensor circuit includes an amplifier having a sense resistor across its input terminals and an output resistor having a high side at which an output voltage can be measured. In an embodiment, the current comparison circuit is a comparator, and the output voltage and a reference voltage are coupled to the comparator's inputs. In an embodiment, a potentiometer is used to set the reference voltage at a level between the negative power input and the positive power input levels.

In an embodiment of a short-circuit switch, a power control signal is input into the base of a transistor through an input resistor. The transistor's emitter is tied to the negative power and the collector is coupled to the input of a buffer circuit. The output of the buffer circuit is coupled to the gate of a second transistor that couples the power input and the power output. The second transistor is switched off and on by the microcontroller through the power control signal.

In an embodiment, the network power controller also includes an H-bridge driver and a line switch.

In various embodiments of the present invention, the network power controller is coupled to at least one node in the system via a conduit for transferring power and data. In various embodiments, the conduit has two wires. In additional embodiments, the conduit has three or more wires.

Various embodiments of the present invention provide a bidirectional data and power transmission system that has a network power controller that transmits power to the system, at least one node that receives power from and exchanges data with the network power controller, and a power and data conduit. In an embodiment, the conduit has three wires. In an embodiment, the first wire carries positive power, the second wire carries negative power, and the third wire decreases a voltage shifting range by emulating a chassis ground. The third wire may also reduce EMI effects on the system. Various embodiments of the network power controller include a microcontroller, a power current-limit circuit, a power switch circuit, a communications short control switch circuit, and a communications driver circuit. In an embodiment, the communications driver circuit notifies the microcontroller when a communication error occurs and has a Talk/Listen line controlled by the microcontroller. In an embodiment, the microcontroller holds the Talk/Listen line low unless it needs to send data via the conduit.

In an embodiment, the present invention provides a system for bidirectional data and power transmission using an optical fiber. In various embodiments, the system includes a network power controller that has a microcontroller and a transceiver, at least one node that also has a microcontroller and a transceiver, a two-wire conduit through which the network power controller provides power to the node, and an optical fiber coupling the transceivers. Data may be transmitted bidirectionally between the transceivers via the optical fiber. In an embodiment, the system also includes circuitry for converting signals received by the transceiver into electrical signals for input to the microcontroller. In an embodiment, the transceivers each include a light source, e.g., an LED, and a light sensor, e.g., a photo-diode.

In various embodiments, an advantage of the present invention is that it provides an improved system for bidirectional data and power transmission. Another advantage of various embodiments of the present invention is a network power controller that includes circuit protection circuitry. Yet another advantage of the present invention is that various embodiments of the present invention mitigate the effects of EMI on a bidirectional data and power transmission system.

These and other advantages of the invention will be apparent from the description of the invention provided herein.

### BRIEF DESCRIPTION OF THE DRAWINGS

FIG. 1A is a diagram of an embodiment of a power source and an electronic network comprising a network power controller and three nodes.

FIG. 1 is a schematic diagram illustrating an embodiment of the circuit protection circuitry and communication current sense circuitry of an embodiment of a network power controller included within an embodiment of the present invention.

FIG. 2 is a schematic diagram illustrating an embodiment of an H-Bridge Driver of an embodiment of a network power controller included within an embodiment of the present invention.

FIG. 3 is a schematic diagram illustrating an embodiment of a line switch for a two-wire conduit in an embodiment of the present invention.

FIG. 4 is a schematic diagram illustrating an embodiment of a node switch power and communications section in a node included within an embodiment of the present invention.

FIG. 5 is a schematic diagram illustrating an embodiment of node output control included within a node in an embodiment of the present invention.

FIG. 6 is a schematic diagram illustrating an embodiment of the power current sense circuitry in an embodiment of a network power controller included within another embodiment of the present invention.

FIG. 7 is a schematic diagram illustrating an embodiment of a power switch included in a network power controller and each node on the network in an embodiment of the present invention.

FIG. 8 is a schematic diagram illustrating an embodiment of a communications switch included in a network power controller and each node on the network in an embodiment of the present invention.

FIG. 9 is a schematic diagram illustrating an embodiment of a T×D communication driver included in a network power controller and each node on the network in an embodiment of the present invention.

FIG. 10 is a schematic diagram illustrating an embodiment of the power current limit circuitry in an embodiment of a network power controller included within an embodiment of the present invention.

FIG. 11 is a schematic diagram illustrating an embodiment of a power switch included in a network power controller in an embodiment of the present invention.

FIG. 12 is a schematic diagram illustrating an embodiment of a communications switch included in a network power controller in an embodiment of the present invention.

FIG. 13 a schematic diagram illustrating an embodiment of a transmit power pull-down circuit included in a network power controller in an embodiment of the present invention.

FIG. 14 is a schematic diagram illustrating an embodiment of node output control circuitry included within a node in an embodiment of a present invention.

FIG. 15 is a schematic diagram illustrating an embodiment of a communications reflecting circuit included within an embodiment of a network power controller in an embodiment of the present invention.

FIG. 16 is a schematic diagram illustrating an embodiment of a bidirectional fiber optic cable transceiver included within an embodiment of a system for distributing power and data.

### DETAILED DESCRIPTION OF THE INVENTION

Various embodiments of the present invention provide a digital current system. Various embodiments of the system provide for bidirectional communications and power transmission between a network power controller and nodes on the network. In an embodiment, the system includes two wires for the transmission of data and power. In another embodiment, the system includes three wires for the transmission of data and power. In still another embodiment, the system includes two wires for the transmission of power and an optical fiber for the transmission of communications.

### Two-Wire Digital Current System

In an embodiment, the present invention provides a two-wire digital current system. In an embodiment of the two-wire digital current system, a two-wire conduit such as a twisted pair or coaxial cable is used to link elements in a system for bidirectional communication and power transport.

In an embodiment, a two-wire conduit is used to link a network power controller (NPC) and at least one node. The NPC and node communicate bi-directionally over the two-wire conduit through which the node also receives power from the NPC. In an embodiment, the NPC and each node include a microcontroller, e.g., a 68HC908GP32, that sends and receives analog and digital signals to and from the NPC and nodes. The digital and analog inputs to the microcontrollers may be translated into data at the NPC and the nodes for transmission to their respective outputs.

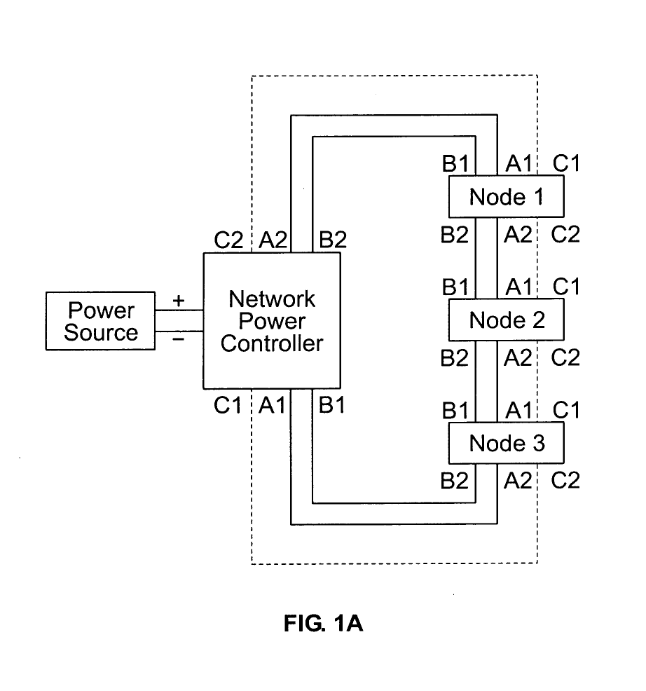

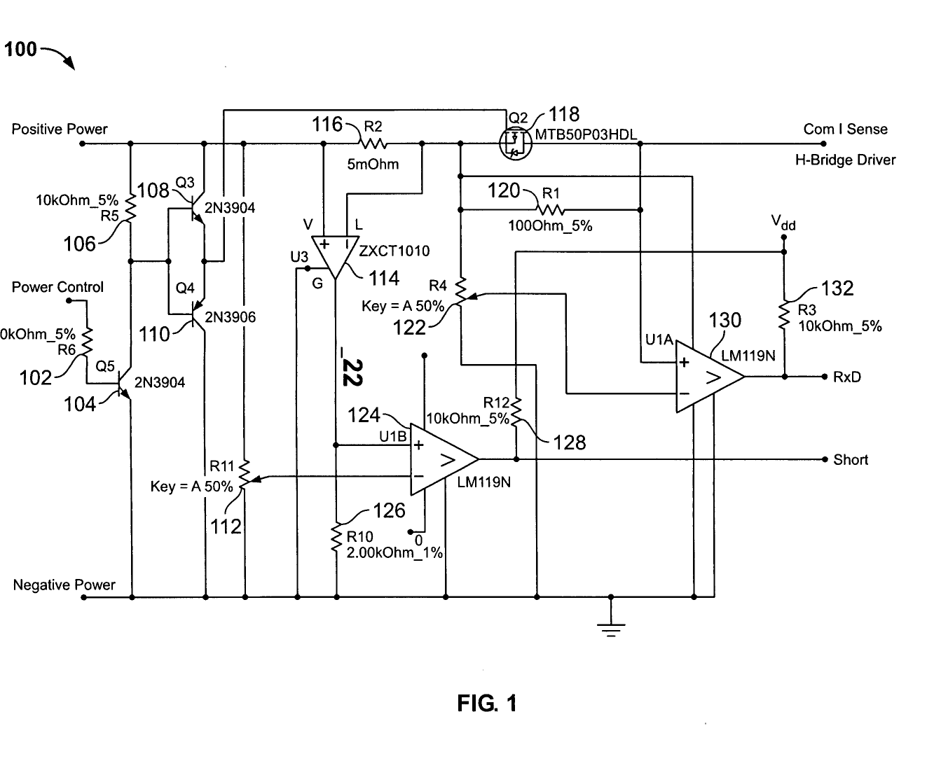

In an embodiment, a network power controller (NPC) powers and controls three separate nodes. The NPC could power and control greater or fewer nodes as the system has been designed to accommodate any number of nodes and is expandable to the limits of its components. In an embodiment, the NPC and nodes within the network are arranged in a loop circuit, as shown in FIG. 1A. The NPC and nodes could also arranged in other configurations, e.g., in a straight branch or in multiple straight branches.

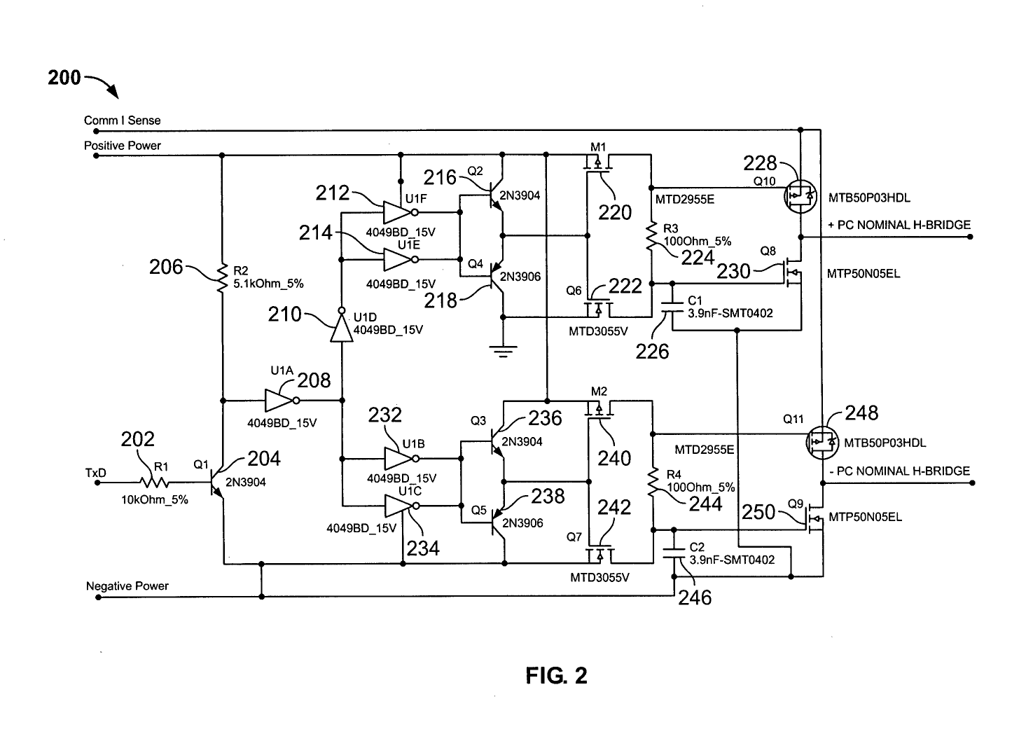

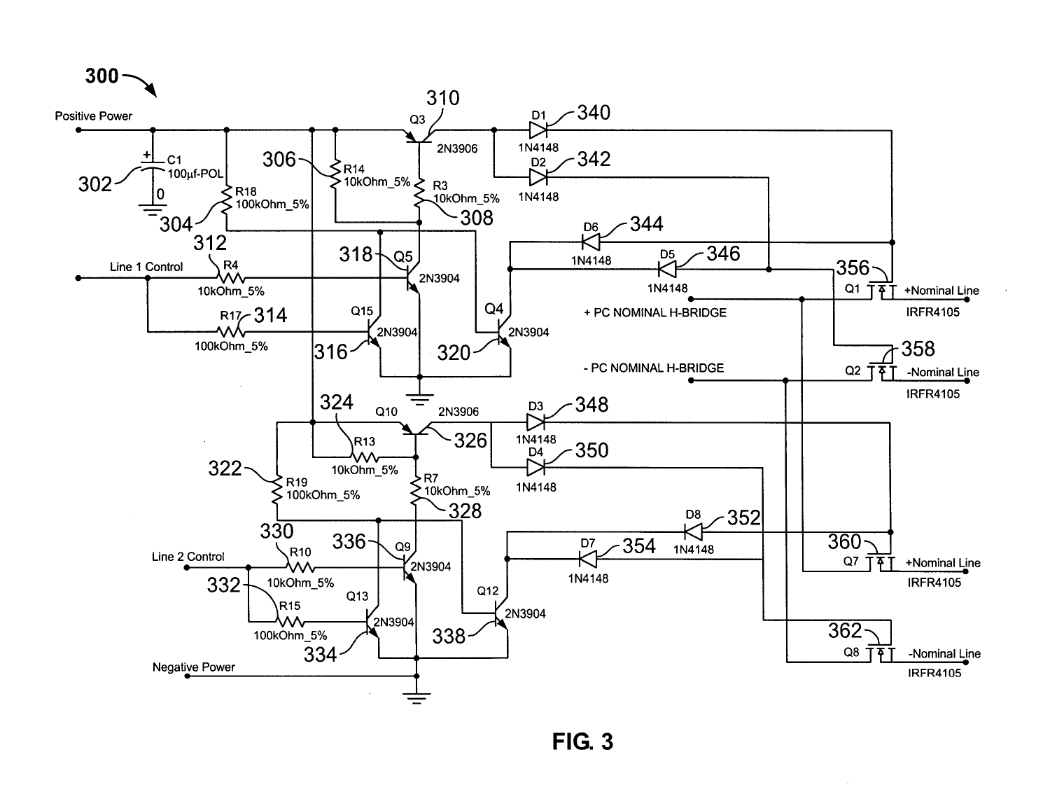

In an embodiment, the NPC comprises a communication and current sense portion 100, an H-Bridge driver 200, a microcontroller, and an NPC line switch 300. In an embodiment, system power is provided to the NPC via a two-lead power connection, e.g., a positive and negative battery power. In an embodiment, as shown in FIG. 2, the H-Bridge driver 200 receives a current sense signal (“Comm. I-Sense”) from the communication and current sense portion and outputs a positive signal referred to as “+PC Nominal H-Bridge” and a negative signal referred to as “−PC Nominal H-Bridge.” In an embodiment, as shown in FIG. 3, the NPC line switch 300 receives the signals output by the H-Bridge driver 200 and outputs two positive nominal lines (“+Nominal Lines”) and two negative nominal lines (“−Nominal Lines”) that go out to each node. In FIG. 1A, the +Nominal Lines are represented by lines A1 and A2, and the −Nominal Lines are represented by lines B1 and B2. In an embodiment, a third wire or conduit may also connect the NPC and the nodes, as illustrated with lines C1 and C2 of FIG. 1A.

In an embodiment, each node comprises a microcontroller, a node switch, and a node switch power and communications section 400. In another embodiment, a node includes a node output control 500.

In an embodiment, as shown in FIG. 1, system power is provided to the NPC via a positive battery power connection and a negative battery power connection. In an embodiment, circuit protection circuitry is provided to the NPC. In an embodiment, the positive battery power flows into the NPC through a power resistor R2 116, e.g., a 5 mOhm power resistor, and a high current p-channel power FET Q2 118 out to the H-Bridge Driver 200 as the current sense signal Comm. I-Sense. In an embodiment, the power resistor R2 116 through which the positive battery power flows is also connected to a high-side amplifier U3 114 for measuring maximum currents on the system. The output of this amplifier is coupled to the input of an output comparator U1B 124. The output from the output comparator U1B 124, which is referred to as the “Short” signal, is coupled to the microcontroller and indicates to the microcontroller when an over-current condition has been detected. When an over-current condition is detected, the microcontroller may turn off the power to the remainder of the system via a power control signal.

In an embodiment, the power control signal is output from the microcontroller to a short-circuit protection circuit. In an embodiment, the short-circuit protection circuit comprises a short-circuit switch coupled to the p-channel power FET through which the battery power flows to the H-Bridge driver 200. In an embodiment, as shown in FIG. 1, the short-circuit switch is comprised of an input to a resistor R6 102 that is coupled to the base of a NPN transistor Q5 104, wherein the emitter of the transistor Q5 104 is coupled to the negative battery power and the collector of the transistor Q5 104 is coupled to a the input of a buffer comprised of NPN transistor Q3 108 and PNP transistor Q4 110. In an embodiment, resistor R5 106, e.g., a 10 kOhm resistor, is connected between the positive battery power and the buffer input. In an embodiment, the buffer output is coupled to the power FET Q2 118 through which the battery power flows to the H-Bridge driver 200. When the micro-controller sends a high signal to the short-circuit switch, the NPN transistor Q5 104 turns on, thereby causing the power FET Q2 118 to turn on.

In an embodiment, a resistor R1 120, e.g., a 100 Ohm resistor, is coupled to the power FET Q2 118. When the NPC is in the communications mode and the power FET Q2 118 is turned off, the resistor R1 120 attempts to hold Comm. I-Sense high. Communications signals from the nodes to the NPC are felt across resistor R1 120. The low side of resistor R1 120 and a voltage signal from potentiometer R4 122 are input to a comparator U1A 130. An output signal for received communications R×D is generated by comparator U1A 130. The voltage on resistor R1 120 will drop as the loads at the nodes pull down the capacitors at each node. Accordingly, the speed of communications should be as high as possible to prevent as much of this drop as possible.

In an embodiment of the present invention, the NPC may send a response to a node from which it has received a communication. In an embodiment, the NPC may also contact the node before the node has contacted the NPC. To communicate with a node, the microcontroller in the NPC is manipulated and a response is sent out via a T×D line. In an embodiment, as shown in FIG. 2, the response signal passes through resistor R1 202 and NPN transistor Q1 204 to the H-Bridge Driver Control, which includes U1, Q2 216, Q3 236, Q4 218, Q5 238, M1 220, Q6 222, Q7 242, and M2 240. The H-Bridge Driver Control drives the main power output H-Bridge power transistors Q10 228, Q11 248, Q8 230, and Q9 250. The outputs of the H-Bridge power transistors Q8-Q11 230,250, 228, 248 are combined to form the +PC Nominal H-Bridge signal and the −PC Nominal H-Bridge signal. These signals are opposite in polarity and change polarity under the control of the NPC's microcontroller and the T×D line.

In an embodiment, as shown in FIG. 3, the +PC Nominal H-Bridge line is coupled to transistors Q1 356 and Q7 360, and the −PC Nominal H-Bridge line is coupled to transistors Q2 358 and Q8 362. These transistors are the nominal line switches that are coupled to all of the nodes. The +PC Nominal H-Bridge line and the −PC Nominal H-Bridge line can be turned off and on for short control by the microcontroller via Line 1 Control and Line 2 Control which, in turn, control Q1/Q2 356, 358 and Q7/Q8 360, 362, respectively, to control shorts on the separate nominal line pair, going out to the nodes.

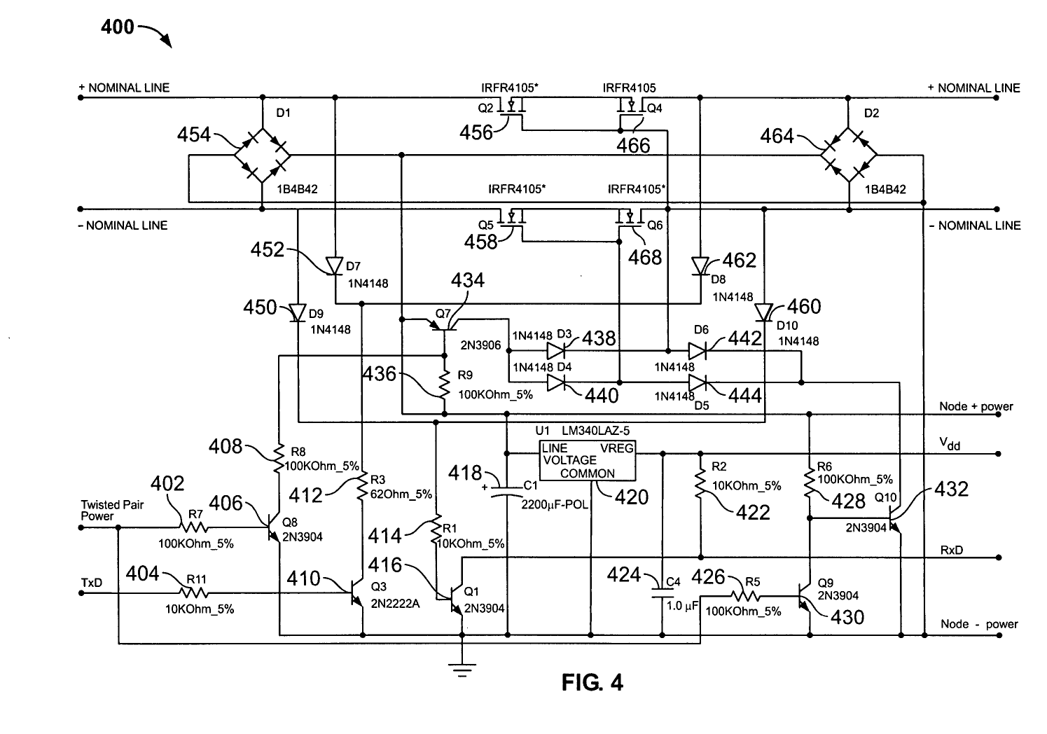

In an embodiment, as shown in FIG. 4, each node includes a node switch power and communications section 400. In an embodiment, this section of the node allows the node microcontroller to receive and send data via its R×D and T×D lines. In an embodiment, the node switch power and communications system 400 is also capable of controlling the two-wire conduit via the power conduit control line coupled to the node's microcontroller. When the power conduit control line is high, transistors Q2 456, Q4 466, Q5 458, and Q6 468 are turned on and allow power to be transmitted through the node to other nodes on the system. When the power conduit control line is low, transistors Q2 456, Q4 466, Q5 458, and Q6 468 are off, and no power can pass through this node to any other node. However, bridges D1 454 and D2 464 are still active and one or the other may receive power on its incoming side and provide power to the node. The output of the bridges D1 454 and D2 464 result in node+power and node−power at each individual node. In an embodiment, a voltage regulator U1 420 provides power (Vdd) to the microcontroller at its corresponding node.

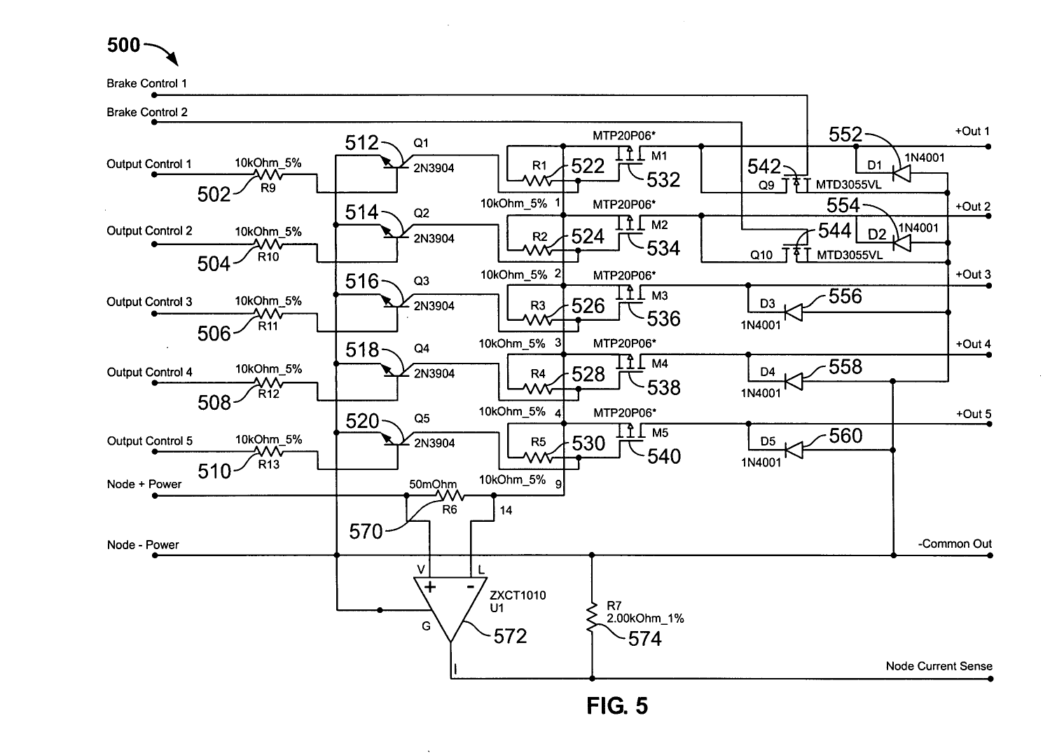

In an embodiment, as shown in FIG. 5, output at a node may be developed via output control 500. Output control lines from the node microcontroller are used for output control 500. The embodiment depicted in FIG. 5 includes five output control lines; however, more control could easily be added by adding additional control lines from the microcontroller. In an embodiment, each node has a resistor R6 570 for output power sense, e.g., a 50 mOhm power resistor, which is connected to a high-side sense current amplifier U1 572. The output of the sense amplifier U1 572 is the Node-Current Sense signal, which is an analog output to the analog input of the node microcontroller. In addition, Brake Control 1 and Brake Control 2 may be added to the outputs to control motors, if necessary. These brake controls are used to hold a motor or other similar device within an electronic current brake state. Associated output control may make the motor or other device operate with any polarity (i.e. direction).

In an embodiment, upon connection to the battery, the NPC receives power, and a 5-volt regulator in the NPC generates a 5 volt signal that is provided to the microcontroller. Upon receipt of the 5-volt signal, the microcontroller begins sending and receiving electronic signals to portions of the NPC.

As described above with reference to FIGS. 1-3, the signals sent by the NPC's microcontroller include Power Control, T×D, Line 1 Control, and Line 2 Control. The Power Control signal turns the main power to the system on and off and controls the communications signals to the system. A high on this signal turns on transistor Q5 104 through resistor R6 102, pulling down resistor R5 106, which pulls down the emitters of the buffer comprising transistors Q3 108, Q4 110, thereby turning on transistor Q2 118 and sending power to the H-Bridge 200.

The T×D signal from the NPC's microcontroller controls the H-Bridge 200. In an embodiment, the H-Bridge 200 includes resistor R1 202, transistor Q1 204, resistor R2 206, amplifier U1 (shown as U1A-U1F 208, 232, 234, 210, 214, 212), transistors Q2-Q5 216, 236, 218, 238, transistors M1-M2 220, 240, transistors Q6-Q7 222, 242, resistors R3-R4 224, 244, capacitors C1-C2 226, 246, and transistors Q8-Q11 230, 250, 228, 248. Transistor Q1 204 is controlled by the signal T×D through resistor R1 202. Q1 204, turning off and on under control, will pull the collector side of R2 206 high and low with respect to the positive battery power. U1A 208 acts as a buffer, inverting this signal. The output of U1A 208 goes directly into U1B 232 and U1C 234, which are, again, inverted, going to the buffers Q3 236 and Q5 238. These, in turn, turn M2 240 and Q7 242 on or off, respectively, where M2 240 is off when Q7 242 is on, and vice-versa. This drives the output drivers Q11 248 and Q9 250, respectively, and controls the polarity of the signal −PC Nominal H-Bridge. In a similar manner, the signal output of U1A 208 is inverted by U1D 210, and sent to the IC Inverters U1E 214 and U1F 212, which drive the buffers Q2 216 and Q4 218, along with M1 220 and Q6 222, in a similar manner as M2 240 and Q7 242, above, which, in turn, drive Q10 228 and Q8 230, producing the signal +PC Nominal H-Bridge. In an embodiment, +PC Nominal H-Bridge and −PC Nominal H-Bridge are always of opposite polarity.

As shown in FIG. 3, the NPC's microcontroller sends Line 1 Control and Line 2 Control signals to control whether or not power and/or data will be sent out via the two-pair of wires called +Nominal Line and −Nominal Line. Line 1 Control controls Q1 356 and Q2 358 via R4 312, R17 314, Q5 318, Q15 316, R18 304, R14 306, R3 308, Q3 310, Q4 320 and diodes D1 340, D2 342, D5 346, and D6 344. Line 2 Control controls Q7 360 and Q8 362 via R10 330, R15 332, Q9 336, Q13 334, R19 322, R13 324, R7 328, Q10 326, Q12 338 and diodes D3 348, D4 350, D7 354 and D8 352.

When Line 1 Control goes high, transistors Q5 318 and Q15 316 are turned on via resistors R4 312 and R17 314. When transistor Q5 318 turns on, it pulls-on transistor Q3 310, through resistor R3 308, sending positive battery power through diodes D1 340 and D2 342 to the gates of the FETs Q1 356 and Q2 358, turning them on. Transistor Q15 316 turns off transistor Q4 320, allowing the cathodes of diodes D6 344 and D5 346 to float. If Line 1 Control goes low, transistors Q5 318 and Q15 316 respectively, are turned off. Transistor Q5 318 turns off, or allows transistor Q3 310 to turn off, allowing diodes D1 340 and D2 342 to float and transistor Q15 316 allows transistor Q4 320 to turn on, causing diodes D5 346 and D6 344 to pull the gates of transistors Q1 356 and Q2 358 low, thereby turning off transistors Q1 356 and Q2 358.

Line 2 Control similarly controls FETS Q7 360 and Q8 362 through its associated circuitry.

The NPC's microcontroller receives signals Short and R×D.

Under operating conditions, the Power Control line will go high, sending power out the Comm. I-Sense line to the H-Bridge Driver 200, which is under control of the T×D line. The output of the H-Bridge driver 200, +PC Nominal H-Bridge and −PC Nominal H-Bridge, goes to the NPC Line Switch 300 which is, in turn, controlled by Line 1 Control and Line 2 Control. The signals generated by the microcontroller's T×D line go out to all the nodes via the two-wire lines, e.g. twisted-pair lines, +Nominal Line and −Nominal Line. Thus, the flow of power and data from the NPC are controlled by the T×D line and the Power Control Line of the NPC.

The nodes each receive their power from either of the two +Nominal Lines and −Nominal Lines, which are the two-wire lines carrying data and power from the NPC. Local power for the node is generated from the received power at each node. Local power includes Node+Power, Node−Power, and Vdd.

As shown in FIG. 4, the nodes receive data from the NPC and an R×D signal is generated at the node via the −Nominal Line, diodes D9 450 and D10 460, resistor R1 414, transistor Q1 416, and resistor R2 422. The node sends data to the NPC via its T×D line, which is connected to the +Nominal Line of the node through resistor R11 404, transistor Q3 410, resistor R3 412, and diodes D7 452 and D8 462.

In an embodiment, the NPC communicates with a select node by sending a message containing that node's address. The node will recognize its address, and the NPC, at the proper time, will drop power via the Power Control signal. The node will receive data sent by the NPC via its input R×D. The node will then take directed or programmed actions, as dictated by the NPC and/or internode communications received via the NPC. In an embodiment, the node gathers data (i.e. sensors, analog/digital, and/or error messages) and communicates the data back to the NPC. The NPC receives and accepts the data and then conducts appropriate analysis. The NPC then may cause commands and data to be sent to appropriate nodes in order to accomplish programmed functions. During node communication time, all nodes may receive information from any sending node.

### Three-Wire Digital Current System

In an embodiment, the present invention provides a three-wire digital current system. In an embodiment of the three-wire digital current system, elements in a system for bidirectional communication and power transport are linked via a three-wire conductor such as a twisted pair plus ground or a coaxial cable plus ground.

The loop structures disclosed above with reference to a two-wire digital current system may also be used, with minor modification, in a three-wire iteration of the technology. Again, depending upon use, the network may be laid out in a variety of ways, including, for example, as a loop, a single branch, or as multiple branches.

In an embodiment, the NPC in a three-wire implementation of the system provides current-limiting control to determine the maximum amount of current that is allowed into any portion of the system. This allows each node to have a short-circuit protection capability such that the node prevents system collapse due to a short at or between nodes. In an embodiment, the third wire is used, in conjunction with the main power wire, to mediate incoming and outgoing EMI. This communication wire also has full short protection from ground to high voltage. While the basic form of communications does not change from that disclosed by the current inventors in U.S. Pat. No. 6,906,618, the third wire allows for much higher communications speeds than previously attained. Also, the addition of the third wire assists and enhances the abilities of the system by emulating a chassis ground throughout the system. This allows a strong grounding capability, regardless of the position of the node or its accessibility to a chassis ground. The two main wires (+ and −) may still reverse polarity in order to communicate, but shift only a fraction of the full power level, e.g., 3 to 5 volts, instead of the full power level, e.g., 12 to 24 volts. This reduced voltage shift helps to mitigate EMI generated by a high voltage shift. Thus, advantages of the three-wire system include the ability to handle a higher voltage, provide a central and constant ground, and reduce EMI. Additionally, it carries the advantages of “open” and “short” protection.

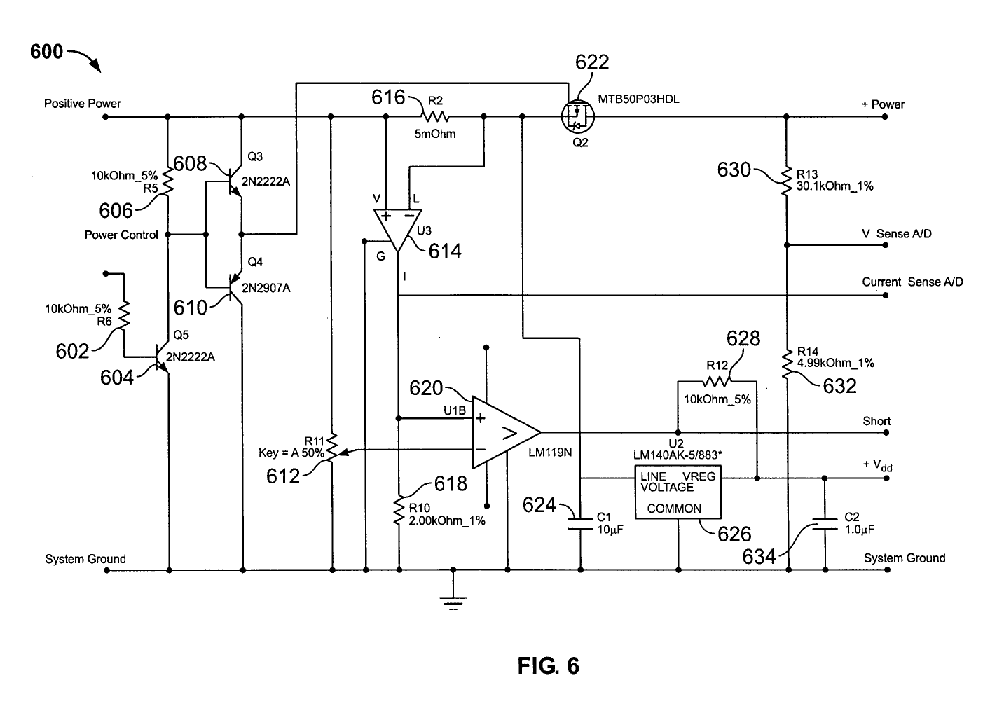

In an embodiment, as shown in the NPC Power I-Sense circuit 600 of FIG. 6, power is provided to the system via a Positive Power (“+Power”) and System Ground in the Power I-Sense circuit 600 within the NPC. A voltage regulator U2 626 receives the input power and produces a Vdd signal (e.g. +5 volts) to power the NPC's microcontroller.

The microcontroller in the NPC may control the +Power to the system via the signal Power Control. If the signal Power Control goes high, this turns on transistor Q5 604 through resistor R6 602, which then pulls the output of the buffer comprised of transistors Q3 608 and Q4 610 low, thereby turning on the p-channel FET Q2 622 and allowing power out to the system.

In an embodiment, the NPC's microcontroller monitors the current and voltage of the system. In an embodiment, power resistor R2 616 senses the current of the system and high-side current sense amplifier U3 614 relays this information to the microcontroller via the analog signal Current Sense A/D. In an embodiment, a comparator U1B 620 senses whether there is an over-current or short condition in the system. The inputs to the comparator U1B 620 are the signals output from the current sense amplifier U3 614 and a potentiometer R11 612. The comparator U1B 620 notifies the microcontroller of any shorts via the signal Short. In an embodiment, the voltage of the system is measured by a voltage divider comprised of resistors R13 630, R14 632 and is relayed to the microcontroller via the analog signal V Sense A/D.

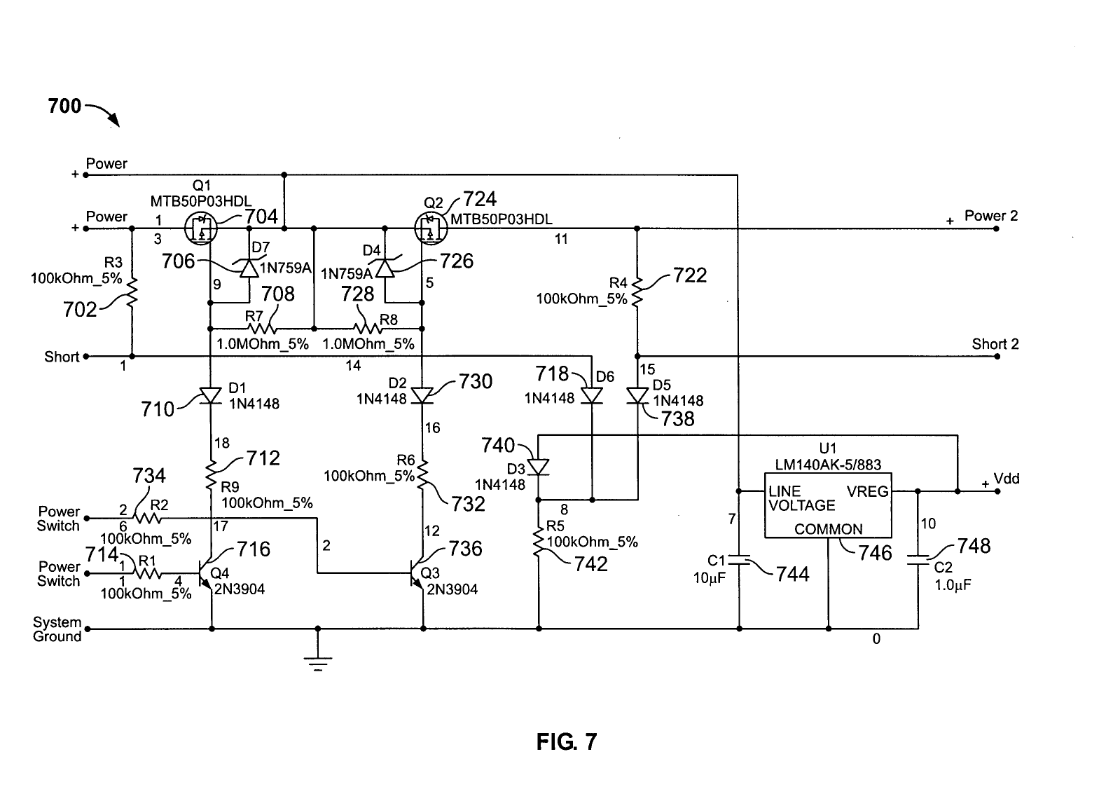

In an embodiment, the NPC and each of the system's nodes include a Power Switch circuit 700. One embodiment of a Power Switch circuit 700 will now be described with reference to FIG. 7.

In the NPC, power comes into the Power Switch circuit 700 via the +Power line from the NPC Power I-Sense circuit 600. This power may be translated through to the outputs +Power 1 and +Power 2 via the transistors Q1 704 and Q2 724, respectively. Transistor Q1 704 may be turned-on via Power Switch 1, which turns-on transistor Q4 716 through resistor R1 714. Transistor Q4 716 may then pull the gate of transistor Q1 704 low, through resistor R9 712 and diode D1 710, thereby turning on transistor Q1 704. In the embodiment illustrated in FIG. 7, transistors Q1 704 and Q2 724 are FETs and transistors Q3 736 and Q4 716 are NPN BJTs. In alternate embodiments, transistors Q1 704 and Q2 724 may be other devices such as, for example, relays, IGBTS, or bipolar transistors. In an embodiment, Zener diode D7 706 prevents overvoltage between the source and gate of transistor Q1 704, thereby protecting the FET. In an embodiment, if the signal Power Switch 1 goes low, then transistor Q4 716 turns off and resistor R7 708 turns off transistor Q1 704, which controls the line +Power 1. The signal Short 1 is an input to the microcontroller that may tell the micro-controller if +Power 1 has power above 5 volts (as in this example) or not.

Transistor Q2 724 may be controlled in a similar manner to transistor Q1 704, via the microcontroller signal Power Switch 2, which, in-turn, may turn on or turn off transistor Q3 736 through resistor R2 734. Transistor Q2 724 may bet turned on via transistor Q3 736, resistor R6 732 and diode D2 730 and may be turned off via resistor R8 728. Zener diode D4 726 provides gate protection to transistor Q2 724. The signal Short 2 is the microcontroller's input to detect whether power is on +Power 2.

In a node, power is received into the Power Switch circuit 700 via either +Power 1 or +Power 2. The intrinsic diodes of transistors Q1 704 and Q2 724 may transport power for the node to the node's +Power line. This power then goes to voltage regulator U1 746 to produce power for the node's microcontroller. Once power is generated to the node, the microcontroller may power-up and initialize, which, in-turn, allows it to turn on Power Switch 1 or Power Switch 2, allowing full voltage and power to the node and passing this power on to the next node.

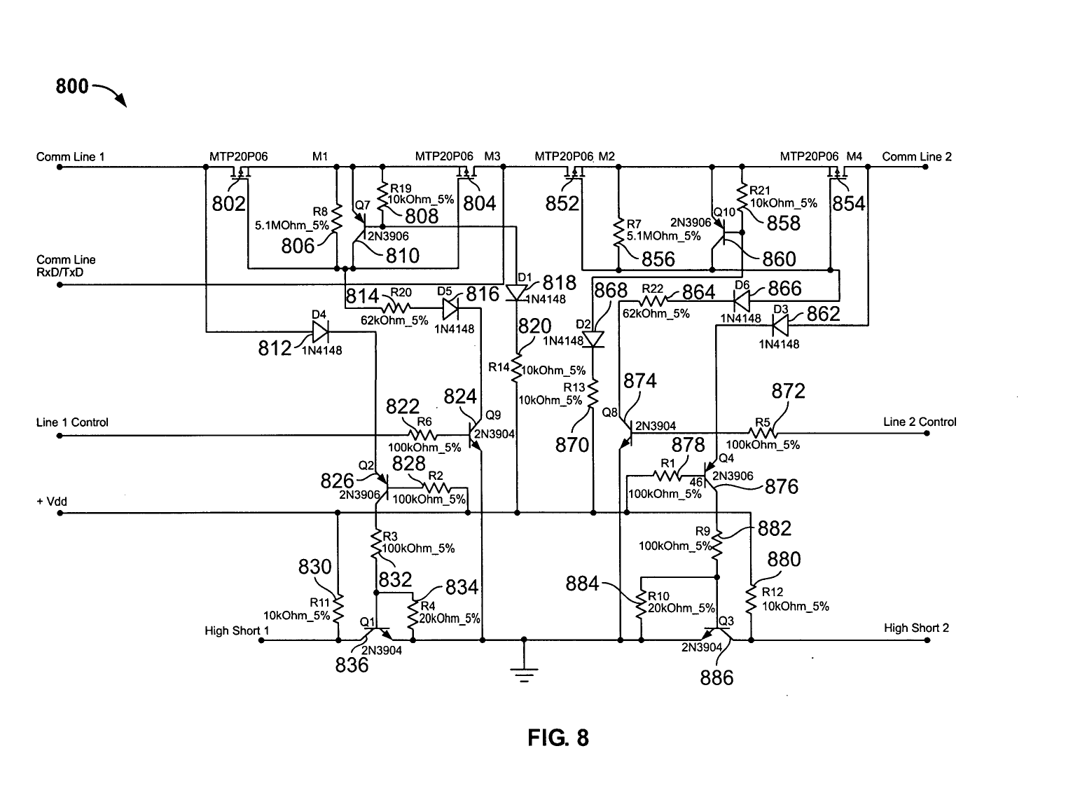

In an embodiment, the NPC and each of the system's nodes include a Communications Switch circuit 800. One embodiment of a Communications Switch circuit 800 will now be described with reference to FIG. 8.

In the NPC, the signal Comm. Line R×D/T×D comes from the signal lines R×D and T×D of the NPC's microcontroller. This signal goes out to between the transistors M2 852 and M3 804. Under microcontroller control, Line 1 Control may go high, which turns on transistor Q9 824 through resistor R6 822. This, in turn, pulls down the gates of transistors M1 802 and M3 804 via transistor Q9 824, diode D5 816 and resistor R20 814, thereby connecting Comm. Line R×D/T×D to the network's Comm. Line 1, and on to a node on the network.

In the same manner, Line 2 Control may go high, turning on transistor Q8 874 through resistor R5 872, which turns-on transistors M2 852 and M4 854 via transistor Q8 874, resistor R22 864 and diode D6 866. This connects Comm. Line R×D/T×D to Comm. Line 2 and on to another node on the network. When transistors M1-M4 802, 804, 852, 854 are all on, Comm. Line 1, Comm. Line 2 and Comm. Line R×D/R×T are all connected together.

If Comm. Line 1 is shorted to a high voltage line, such as +Power 1, this condition will be felt by transistor Q2 826 via diode D4 812, which in turn will turn on transistor Q1 836 through resistor R3 832. This will pull down the signal High Short 1, which will indicate a high-side short on Comm. Line 1. If this occurs, the source area between transistor M1 802 and transistor M3 804 will also go high, which will turn on transistor Q7 810 through resistor R14 820 and diode D1 818, which will turn-off transistors M1 802 and M3 804. This acts as a protection against high-side shorts on the Comm. Line R×D/T×D, which is connected to the microcontroller. A similar circuit consisting of diode D3 862, transistor Q4 876, transistor Q3 886, and resistor R9 882 produce the signal High Short 2 if Comm. Line 2 goes high. In addition, transistor Q10 860, diode D2 868, and resistor R13 870 will turn off transistors M2 852 and M4 854 under this condition in order to protect the microcontroller. If only Comm. Line 1 or Comm. Line 2 is shorted, the Comm. Line R×D/T×D is still connected to the unaffected line.

In an embodiment, transistors M1-M4 802, 804, 852, 854 are FETs. In alternative embodiments, relays, IGBTs, bipolar transistors or other devices may be used instead of FETs.

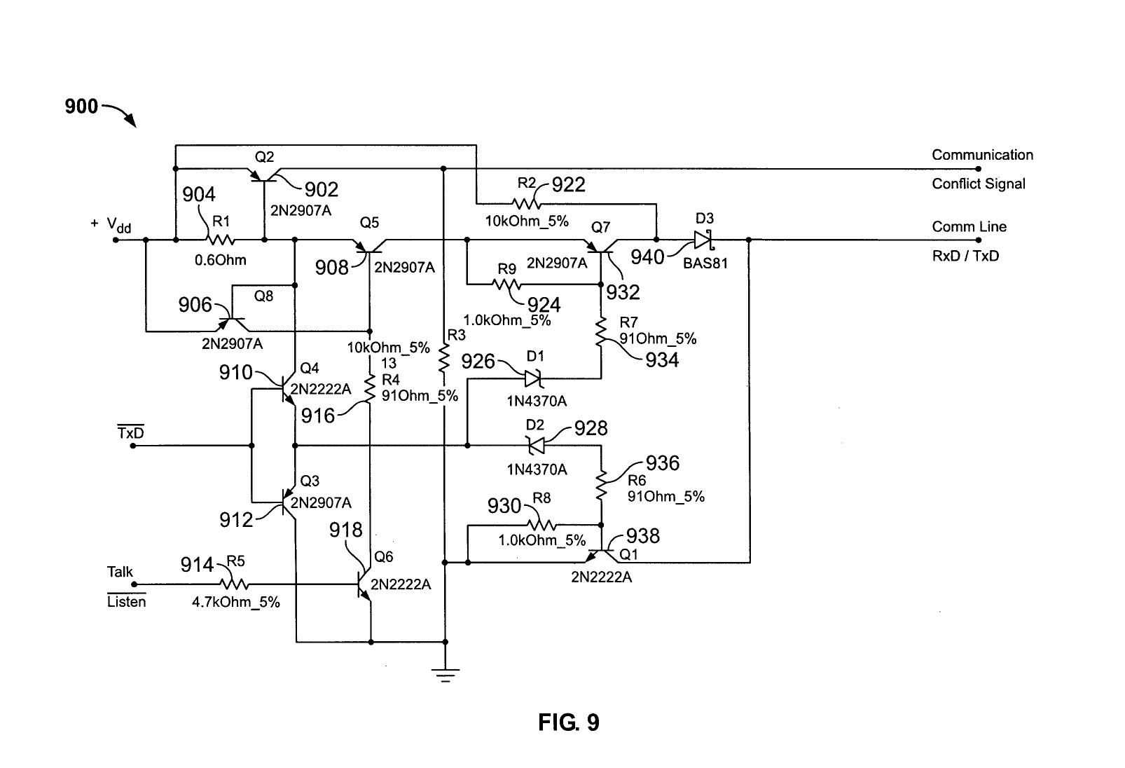

In an embodiment, the NPC and each of the system's nodes include a Communications Driver circuit 900. One embodiment of a Communications Driver circuit 900 will now be described with reference to FIG. 9.

In an embodiment, the Communications Driver circuit 900 comprises the T×D driver for the Comm. Line R×D/T×D line associated with the NPC and each of the system's nodes. A microcontroller holds the Talk/Listen line low, allowing the Comm. Line R×D to float. This is done by turning off transistor Q6 918 through resistor R5 914, which in turn turns off transistor Q5 908 through resistor R4 916, thereby not allowing the +5 Vdd voltage and current to flow into the circuit. At the same time, the T×D Bar signal, through the buffer comprised of transistors Q3 912 and Q4 910, turns off transistor Q1 938 through diode D2 928 and resistor R6 936. This, in turn, allows the Comm. Line R×D/T×D to float (high impedance).

When a microcontroller needs to talk on the network, it will pull the Talk/Listen line high, turning on transistor Q6 918 through resistor R5 914, which turns on transistor Q5 908 through resistor R4 916. This, in turn, supplies power to the emitter of transistor Q7 932. At this time, the T×D Bar signal is low, which turns on transistor Q7 932 through resistor R7 934, diode D1 926, and the buffer comprised of transistors Q3 912 and Q4 910, thereby pulling the Comm. Line R×D/T×D high. When T×D Bar signal goes low, the buffer comprised of transistors Q3 912 and Q4 910 turn on transistor Q1 938 through resistor R6 936 and diode D2 928 and turn off transistor Q7 932 via diode D1 926 and resistor R7 934. This, in turn, pulls the Comm. Line R×D/T×D low. This continues throughout a communications session.

If another microcontroller begins its communication during this time, and it pulls the Comm. Line R×D/T×D low, and this micro-controller tries to pull the Comm. Line R×D/T×D high, high current will be pulled through resistor R1 904, which will turn on transistor Q8 906 and transistor Q2 902. Transistor Q8 906 will turn off or pull down transistor Q5 908, lowering the current and transistor Q2 902 will turn on, pulling the signal Communications Conflict high, thereby signaling the microcontroller that a communications error has occurred.

### High-Side Three-Wire Digital Current System

In an embodiment, the present invention provides another three-wire digital current system. In an embodiment of the three-wire digital current system, elements in a system for bidirectional communication and power transport are linked via a three-wire conductor such as a twisted pair plus ground or a coaxial cable plus ground.

In an embodiment, the present invention includes a controller comprising a Power Current-Limit circuit 1000 (the “Power I-limit circuit”), a Power Switch circuit 1100, a Communications Short Control Switch (“Comm. Switch”) circuit 1200, and a T×D pull-down circuit 1300.

In an embodiment, system power is provided to the NPC via a two-lead power connection, e.g., a positive and negative battery power. System power is non-restricted in voltage, but components should be rated properly for the voltage used.

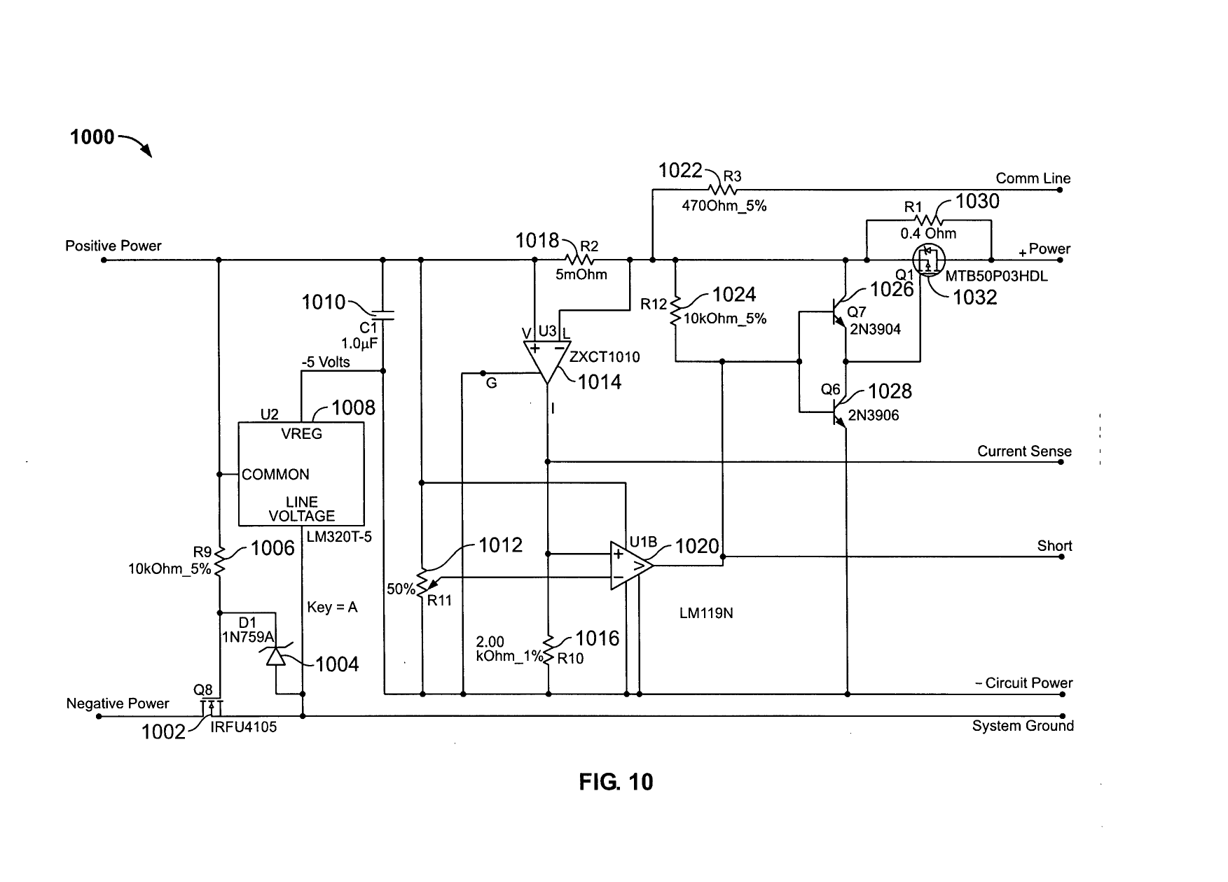

In an embodiment of a Power I-Limit circuit 1000, as shown in FIG. 10, a voltage regulator U2 1008 and a capacitor C1 1010 provide power to the microcontroller and associated electronics included within the NPC. The microcontroller power is designated as −5-volts with respect to the positive system power. The positive power supply is the positive or Vdd for the microcontroller and the −5-volts from the voltage regulator U2 1008 is the ground or Vss for the microcontroller.

The positive battery power flows through power resistor R2 1018, resistor R1 1030, and transistor Q1 1032 to provide system power via the signal +Power. Power resistor R2 1018 is the primary sense resistor for the system. Power for the communications line (“Comm. Line”) is provided from the positive battery power via resistor R3 1022. Resistor R3 1022 also provides resistance signal control for the communications line for the system.

In an embodiment, the NPC includes circuit protection circuitry, as illustrated in FIG. 10. To protect the system from a reversed power connection, the negative battery power input is coupled to the drain an n-channel FET Q8 1002, whose gate is controlled by a resistor R9 1006 and limited by a 12-volt zener diode (D1 1004). The FET Q8 1002 acts as an ultra-low resistance diode structure to prevent power from being incorrectly hooked up in the wrong polarity configuration. The FET Q8 1002 functions as a rectifier in the proper polarity and has a very low on-resistance. If power is reversed upon hook-up, FET Q8 1002 will not conduct and the system is therefore protected. When properly connected, however, FET Q8 1002 conducts with low forward resistance (approximately 5-mOhms). As in the previously described embodiments of the present invention, although FETs are used in this embodiment, other devices such as relays, IGBTs, and bipolar transistors could alternatively be used.

In an embodiment, as shown in FIG. 10, short protection and current limiting are provided by the current controller comprised of high side current sense amplifier monitor U3 1014 and comparator U1B 1020, transistors Q6 1028, Q7 1026, Q1 1032, and resistors R1 1030, R10 1016, R12 1024. The current sense amplifier U3 1014 measures the current in the system through resistor R10 1016. This signal goes to the analog input of the microcontroller and the signal is designated “Current Sense.” The Current Sense signal also goes to comparator U1B 1020 and is compared against the potentiometer setting of potentiometer R11 1012. The potentiometer R11 1012 setting determines the maximum amount of current that the system can accommodate. Power resistor R1 1030, in conjunction with resistor R2 1018, is calculated to be at such a maximum current level also. The output of comparator U1B 1020 is a Short signal provided to the microcontroller.

The output of comparator U1B 1020, in conjunction with resistor R12 1024 and transistors Q6 1028 and Q7 1026, control the power transistor Q1 1032 such that full power is allowed throughout the system until the set point at R11 1012 is reached.

When a short or high current condition occurs and the microcontroller receives a Current Sense signal or a Short signal, transistor Q1 1032 turns off. Power resistors R1 1030 and R2 1018 then hold the full power of the system. When the short or high current condition is removed, the current drops and comparator U1B 1020 and amplifier U3 1014 restore the system to full power.

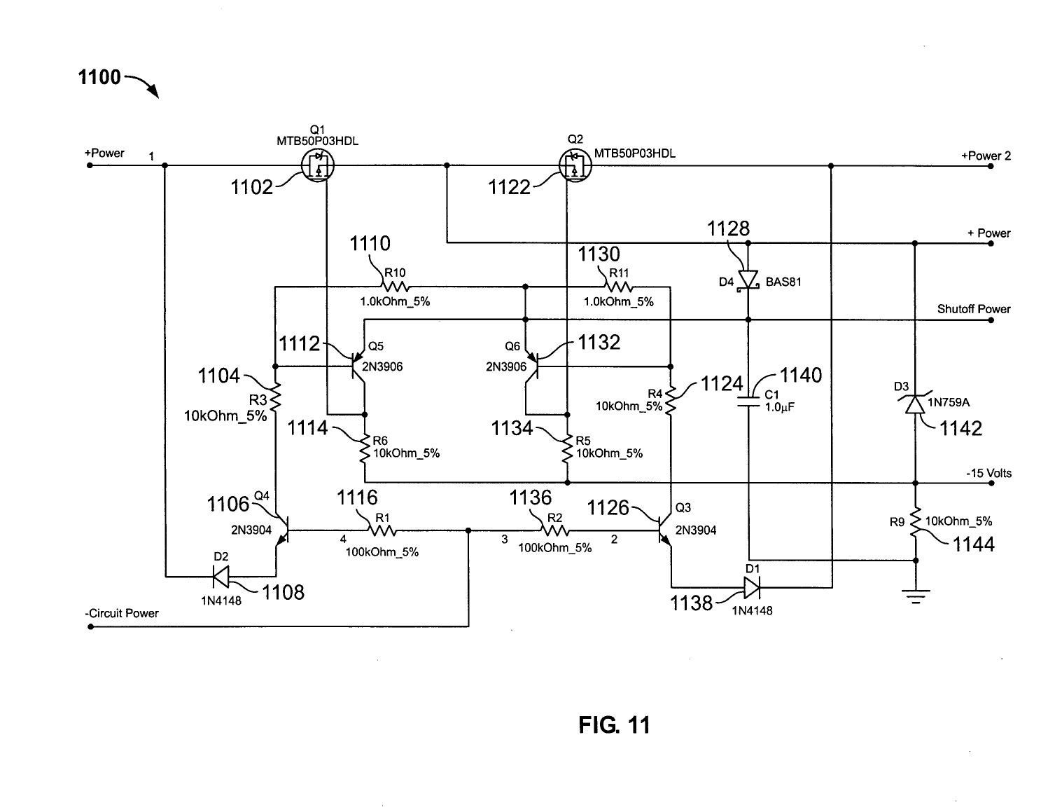

In an embodiment, the NPC includes a Power Switch circuit 1100 such as that shown in FIG. 11. In an embodiment, the Power Switch circuit 1100 includes the main power, short control circuit, and also represents a common-power switch that is common to the NPC and all nodes. As shown in FIGS. 10 and 11, the lines System Ground, +Power, −Power, −5 volts, and the Comm. Line are provided to the Power Switch from the Power I-limit circuit 1000. The +Power signal is the main power to be delivered to the lines +Power 1 and +Power 2. Outputs from the Power Switch circuit 1100 include the signals +Power 1, +Power 2, Shutoff Power, and −15 volts.

In an embodiment, the Power Switch circuit 1100 controls ancillary shorts on the system outside the NPC via controlling the on or off condition of transistors Q1 1102 and Q2 1122. During normal operation, the +Power signal, in conjunction with the 15 volt Zener diode D3 1142 and resistor R9 1144, produce a −15 volt signal, used to turn on the p-channel power FETs Q1 1102 and Q2 1122 through resistors R5 1134 and R6 1114.

If a short to ground or high current load occurs between +Power 1 or +Power 2 and ground, it is sensed by diodes D1 138 or D2 1108, which will turn on transistors Q3 1126 or Q4 1106 through resistors R1 1116 or R2 1136, with respect to the −5 volts generated by voltage regulator U2 1008 of the Power I-Limit Circuit 1000 shown in FIG. 10.

When either of these transistors Q3 1126 and Q4 1106 turn on, they will pull down current through resistors R3 1104 or R4 1124 to turn on transistors Q5 1112 or Q6 1132, which, in turn, turn off the power transistors Q1 1102 or Q2 1122. The power to turn off FETs Q1 1102 and Q2 1122 is generated from the +Power through Schotky diode D4 1128 and capacitor C1 1140 (Shutoff Power signal).

In an embodiment, if a short occurs on +Power 1 line, the result will be that power FET Q1 1102 will turn off, but not power FET Q2 1122, thereby allowing power to go out to the system on +Power 2 line.

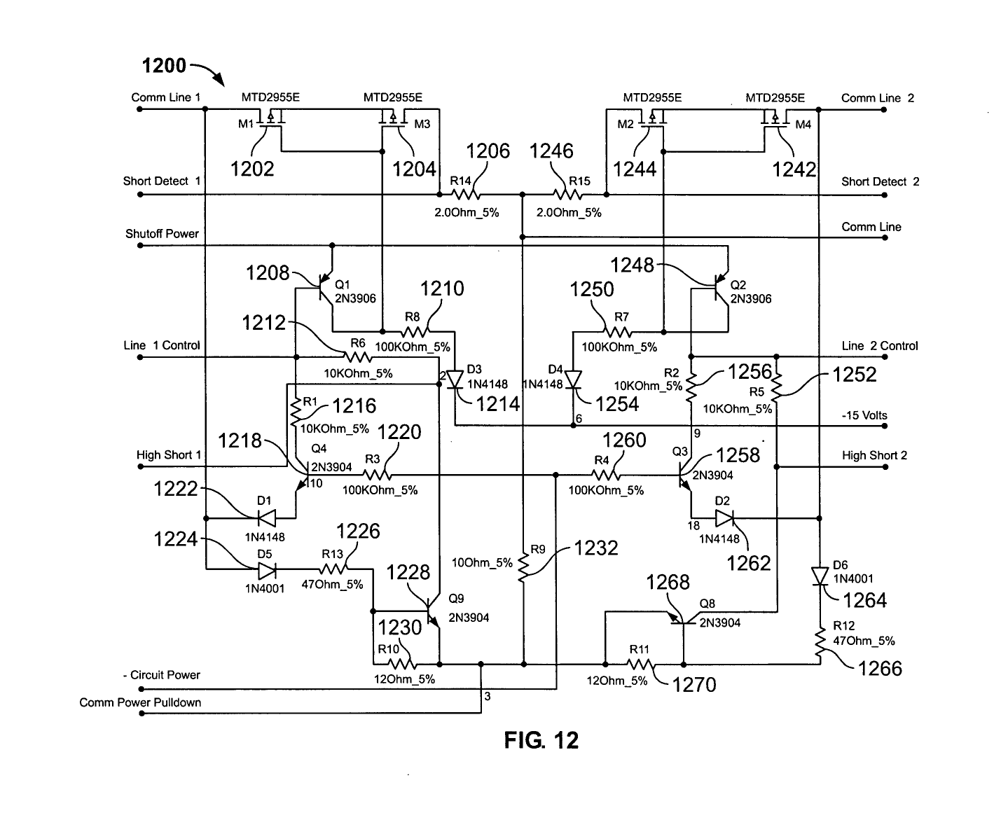

In an embodiment, the NPC also contains a Comm. Switch circuit 1200, an embodiment of which is shown in FIG. 12. The Comm. Line from the resistor R3 1022 of FIG. 10, which is the main input line for the communication system, enters the Comm. Switch circuit 1200 through resistors R14 1206, R15 1246 and goes out to the system along Comm. Line 1 and Comm. Line 2 via power mosfets M1 1202 and M3 1204, resistor R14 1206, mosfets M2 1244 and M4 1242, and resistor R15 1246.

The Comm. Switch circuit 1200 detects shorts on the Comm. Lines to ground and/or to a +Power line. This circuit also passes the communications signals from the microcontroller to this circuit via the Comm. Power Pull-down Line.

The microcontroller has sense lines High Short 1 and High Short 2 for detecting high-side shorts at lines Comm. Line 1 and Comm. Line 2. It also has analog inputs called Short Detect 1 and Short Detect 2, which measure the voltage levels on the Comm. Lines for detecting high-side shorts. In addition, Comm. Line 1 Control and Comm. Line 2 Control are used as part of software control of the Comm. Lines during high-side short testing. Low side shorts are handled automatically, without software control via transistor Q3 1258 and Q4 1218 in conjunction with diodes D2 1262 and D1 1222 and resistors R1 1216 and R2 1256.

During normal operation, when power to the NPC is brought-up, the power FETs (M1 1202, M3 1204 and M2 1244, M4 1242) are turned on via diodes D3 1214 and D4 1254 and resistors R8 1210 and R7 1250. The power generated by the zener diode D3 1142 and resistor R9 1144 of the Power Switch Circuit 1100 (see FIG. 11) provide the power to turn on the above power FETs through signal −15 volts.

In the case of a short or over current condition on Comm. Line 1 (i.e. to the +Power 1 line), this condition is detected by diode D5 1224, resistor R13 1226 and transistor Q9 1228, in conjunction with resistor R6 1212 and transistor Q1 1208. If the Comm. Power Pull-down Line is activated and pulled to a −5 volts, as in standard T×D communications, this will turn on Q9 1228 and, in turn, turn on transistor Q1 1208, turning off the power FETs M1 1202 and M3 1204.

High Short 1 signal line will also go low, signaling the microcontroller that a short has occurred on Comm. Line 1. The microcontroller then pulls Line 1 Control signal high, turning off Q1 and allowing FETs M1 1202 and M3 1204 to again conduct. The microcontroller measures the analog voltage at Short Detect 1 and compares it against an internal standard to determine the location of the short. If it is determined that the short has occurred on Comm. Line 1, immediately adjacent to the node, Line 1 Control is released by the processor and High Short 1 Control is pulled low to hold off FETs M1 1202 and M3 1204, thus isolating the node from Comm. Line 1.

The same sequence occurs on any node or any Comm. Line when the Comm. Power Pull-down Lines are activated.

In the case of a short or over current condition on Comm. Line 1 (i.e. to ground) the condition is detected by diode D1 1222, turning on transistor Q4 1218 and in turn turning on transistor Q1 1208 through resistor R1 1216 in conjunction with resistor R3 1220. This will turn off power FETs M1 1202 and M3 1204, thereby blocking communications signals on Comm. Line 1. The same condition is true on Comm. Line 2 through diode D2 1262, transistors Q3 1258 and Q2 1248, and resistors R2 1256 and R4 1260.

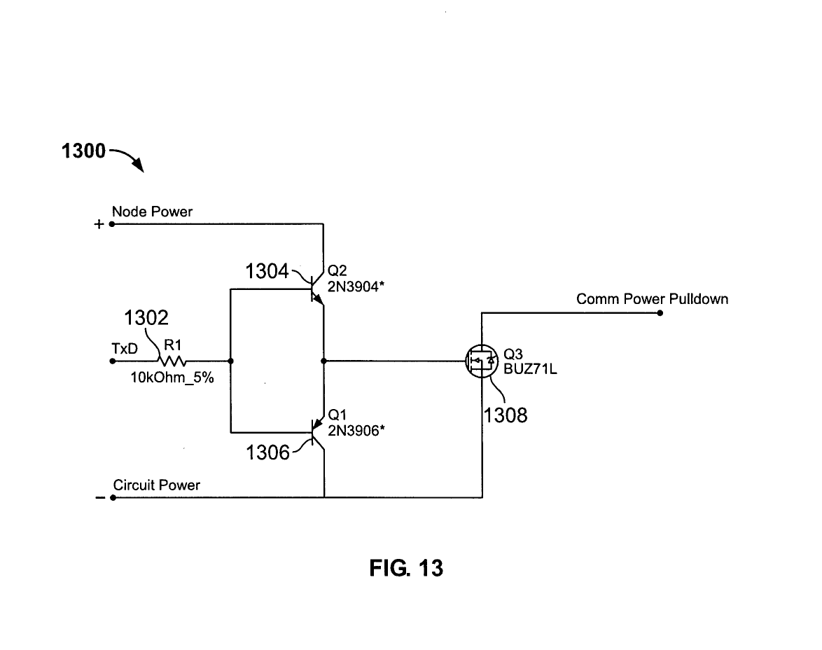

In an embodiment, the NPC includes a Transmit Power Pull-down circuit 1300 (“T×D Pull-down”). As shown in FIG. 13, the Comm. Power Pull-down Line of the T×D Pull-down circuit 1300 is coupled to the Comm. Power Pull-down of FIG. 12. The T×D line is attached to the associated circuitry of either the NPC or the individual node. In an embodiment, a signal from the microcontroller to T×D, going through resistor R1 1302, controls transistors Q1 1306 and Q2 1304 of FIG. 13. These transistors Q1 1306 and Q2 1304 in turn control Power FET Q3 1308 and connect the signal through to the Comm. Power Pull-down line of FIG. 12, thereby allowing the NPC to transmit data to the system.

Each node has a microcontroller that may accomplish several functions, including the receipt of data, storage of data, transmission of data and preprogrammed actions determined by data.

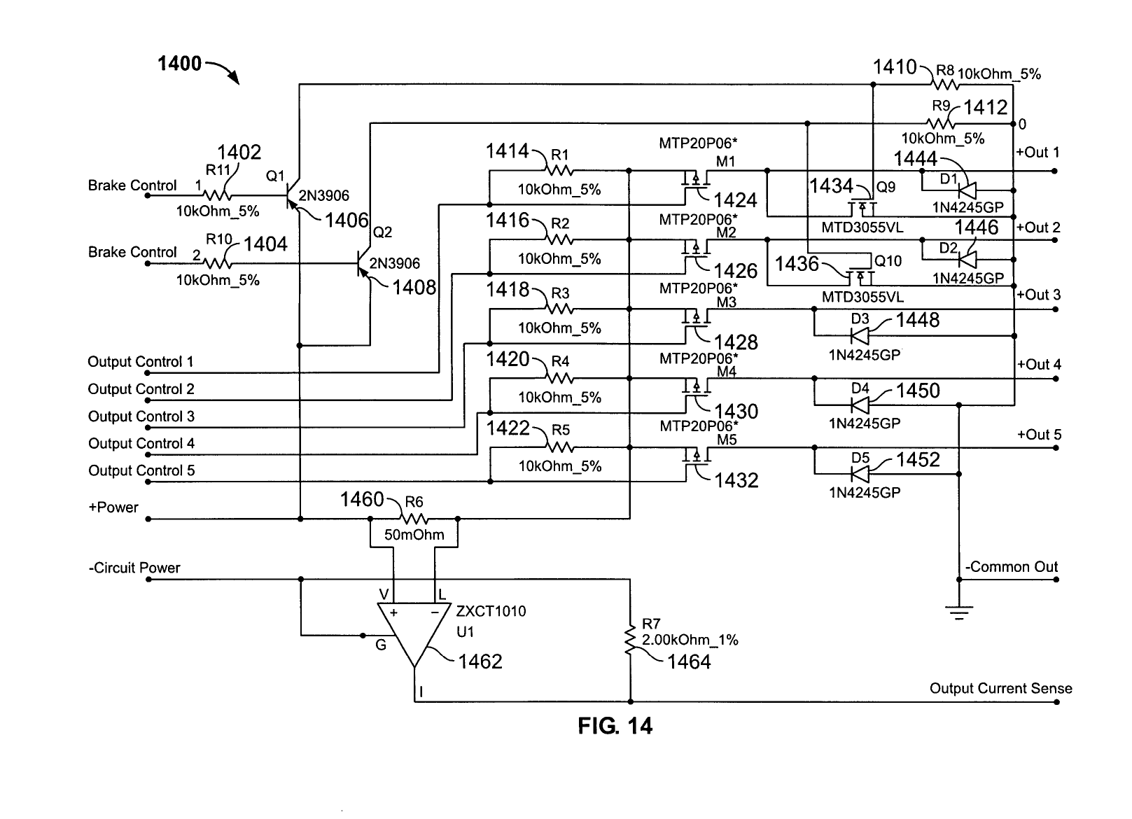

In an embodiment, the present invention includes a fully variable voltage node system with output control. An embodiment of such output control will now be described with reference to FIG. 14, which represents the general output control for a given actuator node. In this embodiment, Output Control 1 through Output Control 5 control the associated primary output power FETs M1-M5 1424, 1426, 1428, 1430, 1432. Power resistor R6 1460 is the current sense resistor for the output control and, in association with high-side current sense amplifier U1 1462 and resistor R7 1464, gives an analog current signal (Output Current Sense) to the node microcontroller. The signals +Out 1 through +Out 5 may be connected to any appropriate node, whose output is minus common output out (common ground). In addition, Brake Control 1 and Brake Control 2, with +Out 1 and +Out 2 may control motors or other similar devices.

In the case of multiple actuation outputs, the five output control circuit illustrates how this action is performed. The microcontroller sends signals to Output Control 1 through Output Control 5, as required, to turn on or off Power FETs M1 1424 through M5 1432, and out to the actuators placed on +Out1 through +Out5. In addition, Brake Control 1 and Brake Control 2 signals from the processor, activate power FETs Q9 1434 and Q10 1436 to control bidirectionality of motors and/or other polarity specific components.

Power resistor R6 1460 monitors the overall current of this output setup in conjunction with high side amplifier U1 1462 and resistor R7 1464. The output of this combination is an analog signal, Output Current Sense. Any time the Output Current Sense signal rises above a preprogrammed level, a diagnostic program is run to determine which line (+Out1 through +Out5) is experiencing such overcurrent condition.

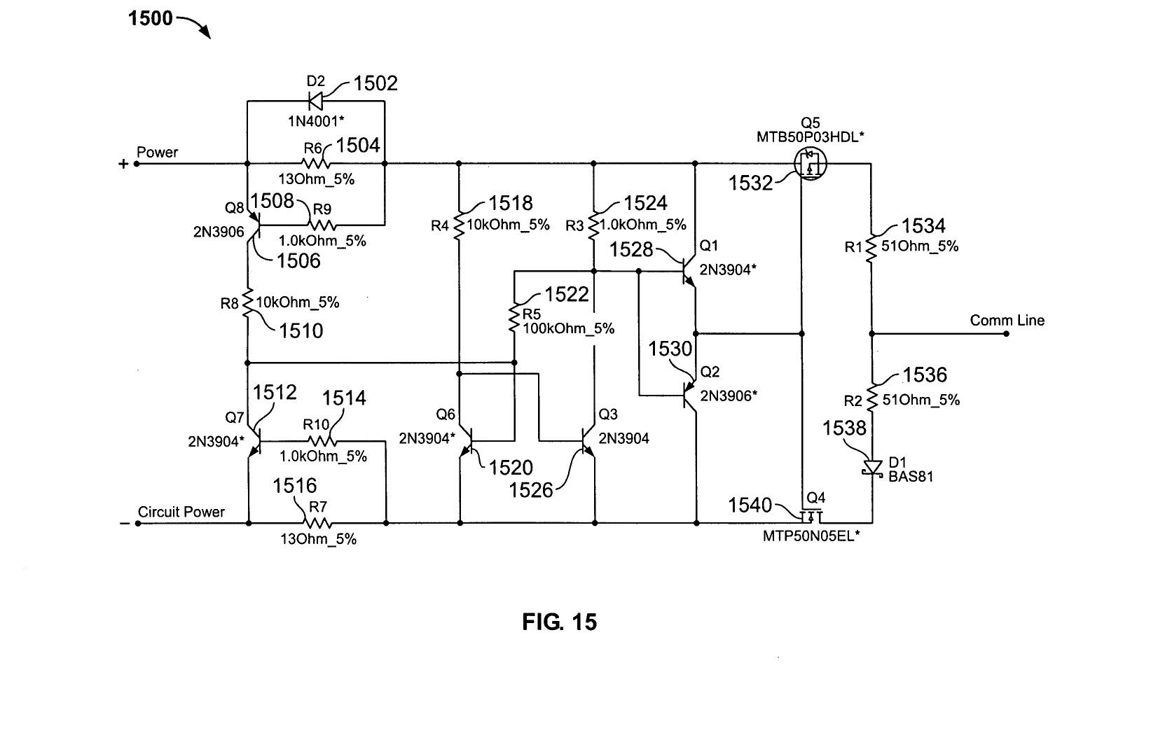

In an embodiment, the NPC includes a communications reflecting circuit 1500. An embodiment of a communications reflecting circuit 1500 is shown in FIG. 15. The communications reflecting circuit 1500 is a power active replacement for resistor R3 1022 of the Power I-Limit circuit (see FIG. 10). In conditions of very high external Electromagnetic Interference (EM1), the resistor R3 1022 could be overwhelmed. In this condition, a more robust communications line reflection system should be used. As shown in FIG. 15, in an embodiment, this system consists of two current sense resistors, R6 1504 and R7 1516, which detect high current pull-down or pull-up on the reflector. When one of these resistors is activated, it causes the shift of output control through Power FETs Q4 1540 or Q5 1532 and through resistors R1 1534 and R2 1536.

### Digital Current System Including an Optic Fiber for Communication

In an embodiment of the present invention, communications between a NPC and nodes on a network are handled via transceivers and an optical fiber. Various embodiments of the present invention provide a digital current system including an optical fiber, wherein a communications circuit comprising the optical fiber and transceivers replace the communications aspects of the two-wire and three-wire systems described above.

In an embodiment, dual power conduits are used for power transmission and communications are transmitted via the optical fiber. Exemplary dual power conduits include a twisted pair wire, a coaxial cable, or a wire and a chassis ground.

Using an optical fiber or third wire to carry data separate from system power allows for a 100% duty cycle on the power and thus eliminates the need for circuitry to accommodate a less than 100% duty cycle power supply to the system at all times. Also, under some conditions, communications via a metal wire may not be appropriate due to EM1 or communications speed requirements. Various embodiments of the present invention eliminate most transmitted EM1 and are very resistant to external EM1. Also, when proper components are selected, using an optical fiber to transfer data can result in a significantly increased communications speed. For example, in an embodiment, communications speeds may reach into the multiple giga-baud range.

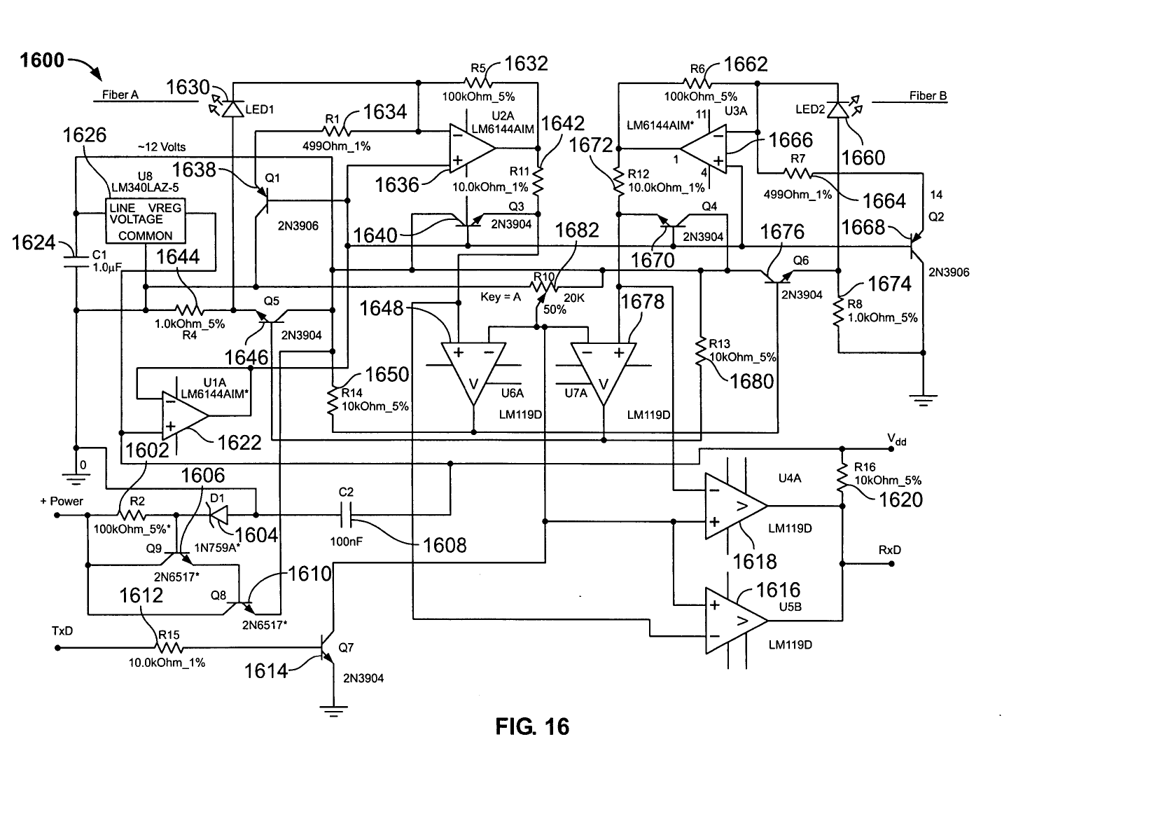

In an embodiment of the present invention, the NPC and each node on the network have a bidirectional fiber optic cable transceiver 1600. One embodiment of such a transceiver will now be described with reference to FIG. 16, which is a schematic diagram illustrating an embodiment of a bidirectional fiber optic cable transceiver 1600 included within an embodiment of a system for distributing power and data.

Power is provided to the transceiver via the +Power feed from the NPC. A voltage regulator, resistor R2 1602, Zener diode D1 1604, and transistors Q8 1610, Q9 1606 provide main power to the fiber optic transceiver 1600. An additional voltage regulator U8 1626, e.g., a 5 volt regulator, provides power, e.g., +5 volts, to the remainder of the fiber optic transceiver 1600 and to the associated microcontroller.

Under normal operations, outgoing communications from the transceiver come from the T×D signal of the microcontroller in either the NPC or the node, depending on the location of the transceiver, into resistor R15 1612 and transistor Q7 1614. The signal is translated though U4A 1618 and U5B 1616 and out to the signal R×D and back to the receive side of the microcontroller. Hence when there is no signal being transmitted out, the T×D signal is held low and the collector of transistor Q7 1614 is allowed to float to the setting of potentiometer R10 1682.

When transistor Q7's 1614 line goes low, via signals from T×D, the negative inputs of comparators U6A 1648 and U7A 1678 go low, with respect to the positive inputs. The outputs of U6A 1648 and U7A 1678 go to resistors R14 1650 and R13 1680, respectively, and to transistors Q6 1676 and Q5 1646, respectively.

In an embodiment, light goes out Fiber A via LED 1 1630 and out Fiber B via LED 2 1660. When transistor Q5 1646 is turned on by comparator U7A 1678, LED 1 1630 turns on and emits light. When Q5 1646 turns on, forward-biased current flows through resistor R1 1634 and turns on transistor Q1 1638, thereby turning on LED 1 1630. LED 2 1660 turns on in the same manner via transistors Q6 1676 and Q2 1668 through resistor R7 1664.

Under normal operations, incoming communications are detected by the LED associated with the fiber carrying the communications via the LED's ability to act as a photo-diode. When light from the fiber strikes the PN junction of the LED, a receivable signal is produced.

When light from fiber A is detected by LED 1 1630, the resulting signal is amplified by amplifier U2A 1636, its associated resistor R5 1632, and the reference at the +input of the amplifier U2A 1636. Under dark conditions, the off condition of comparators U6A 1648 and U7A 1678 is adjusted by potentiometer R10 1682 and the output of amplifier U2A 1636 and U3A 1666. U6A 1648, U7A 1678, U4A 1618 and U5B 1616 are normally in a dark condition (biased off).

When a signal (light) comes through fiber A and strikes LED1 1630, LED 1 1630 begins to conduct, causing the output of amplifier U2A 1636 to rise. As it rises, this signal rises above the set point of potentiometer R10 1682, controlling the inputs to U6A 1648, U7A 1678, U4A 1618 and U5B 1616, turning on U6A 1616+ and turning U5B 1616 low. When U6A 1648 goes +, Q6 1676 turns on and is pulled to +12 volts, turning on LED 2 1660 through R7 1664 and Q2 1668, which also turns on, thereby sending the signal (light) down fiber B to the next associated node.

Under normal operations, incoming communications via fiber B is conducted in similar, yet opposite, manner from fiber A, while still controlling the R×D output.

Therefore, any signal coming from either direction into the node or NPC shall be in turn sent out via the opposite fiber of the node or NPC, thereby completing loop communications.

In an embodiment, a light source other than an LED is paired with a light sensor, e.g., a photo-detector, for sending and receiving communications. Various light sources including LEDs, laser diodes and micro-cavity lasers may be used to send signals across an optic fiber.

In various embodiment of the present invention, both plastic and glass optic fibers are used. While plastic optic fibers are able to transmit a broad range of colors or frequencies, signals with a mid-range wavelength, e.g., green and colors spectrally close to green, or signals in the infra-red range work particularly well. With respect to glass fibers, lower range wavelengths, e.g., 1.2 to 1.5 microns, corresponding to deep-infra-red light work well.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A network power controller in a system for bidirectional data and power transmission, the network power controller comprising:
a power input for receiving positive power and negative power from a DC power source;
a short-circuit circuit protection circuit coupled to the power input;
a power output for transmitting power and data to nodes in the system, wherein the power output is coupled to the short-circuit protection circuit; and
a microcontroller for processing signals sent and received by the network power controller, wherein the microcontroller controls transmission of power to the nodes in response to receiving a short-circuit signal from the short-circuit protection circuit.

2. The network power controller of claim 1, wherein the short-circuit protection circuit comprises a short-circuit detection circuit coupled to the power input and a short-circuit switch controlled by the microcontroller and coupled to the power output.

3. The network power controller of claim 2, wherein the short-circuit detection circuit comprises:
a current sensor, wherein the power input is coupled to a current sensor input and the current sensor output is a first voltage corresponding to a sensed current; and
a current comparison circuit, wherein the current comparison circuit compares the first voltage with a reference voltage, and wherein the current comparison circuit provides feedback to the microcontroller via a short-circuit signal.

4. The network power controller of claim 3, wherein the current sensor comprises:
a sense resistor, the sense resistor having a first lead and a second lead, wherein the first lead is coupled to the positive power input;
an amplifier, the amplifier having a positive input coupled to the first lead, a negative input coupled to the second lead, and an amplifier output; and
an output resistor, the output resistor having a third lead and a fourth lead, wherein the fourth lead is coupled to the negative power input and the third lead is coupled to the amplifier output and provides the first voltage.

5. The network power controller of claim 3, wherein the current comparison circuit comprises a comparator, wherein the reference voltage is coupled to a negative input terminal and the first voltage is coupled to a positive input terminal.

6. The network power controller of claim 3, wherein the reference voltage is set by a potentiometer having a voltage range from the negative power to the positive power.

7. The network power controller of claim 2, wherein the short-circuit switch comprises:
a buffer circuit having a buffer input and a buffer output;
a resistor, the resistor having a first lead and a second lead, wherein the first lead detects a power control signal from the microcontroller;
a first transistor, wherein the first transistor has a first emitter, a first collector, and a first base, and the first emitter is coupled to the negative power, the first base is coupled to the second lead, and the first collector is coupled to the buffer input; and
a second transistor, wherein the second transistor has a first source coupled to the positive power input, a first drain coupled to the power output, and a first gate coupled to the buffer output.

8. The network power controller of claim 7, wherein the buffer circuit comprises:
a third transistor, wherein the third transistor has a second emitter, a second collector, and a second base;
a fourth transistor wherein the fourth transistor has a third emitter, a third collector, and a third base;
a buffer input that is coupled to the second base and the third base; and
a buffer output that is coupled to the second emitter and the third emitter.

9. The network power controller of claim 1, the network power controller further comprising:
an H-bridge driver; and
a line switch.

10. The network power controller of claim 1, wherein the power output of the network power controller is coupled to at least one node in the system via a two-wire conduit for transferring power and data.

11. The network power controller of claim 1, wherein the power output of the network power controller is coupled to at least one node in the system via a conduit for transferring power and data, wherein the conduit comprises three or more wires.

12. A bi-directional data and power transmission system, the system comprising:
a network power controller, wherein the network power controller transmits power to the system;
at least one node, wherein the node receives power from the network power controller and exchanges data with the network power controller; and
a conduit through which the node receives power from the network power controller and exchanges data with the network power controller, the conduit comprising a first, second, and third wire, wherein the first wire carries positive power, the second wire carries negative power, and the third wire decreases a voltage shifting range by emulating a chassis ground.

13. The system of claim 12, wherein the network power controller comprises a microcontroller, power current-limit circuit, a power switch circuit, a communications short control switch circuit, and a communications driver circuit.

14. The system of claim 13, wherein the communications driver circuit comprises:
an error notification circuit, wherein the error notification circuit detects conflicts on the conduit and notifies the microcontroller when a communications error occurs; and
a Talk/Listen line, wherein the microcontroller holds the Talk/Listen line low when the microcontroller does not need to transmit data via the conduit and the microcontroller pulls the Talk/Listen line high when the microcontroller needs to send data via the conduit.

15. The system of claim 12, wherein the third wire reduces EM1 effects on the system.

16. A system for bidirectional data and power transmission, the system comprising:
a network power controller including a first transceiver and a first microcontroller;
a node including a second transceiver and a second microcontroller;
a two-wire conduit for power, wherein power is provided to the node from the network power controller via the two-wire conduit; and
an optical fiber coupling the first transceiver to the second transceiver, wherein data is transmitted bidirectionally between the first transceiver and the second transceiver via the optical fiber.

17. The system of claim 16, the system further comprising circuitry for converting signals received by the first transceiver or the second transceiver into electrical signals for input into the first microcontroller or the second microcontroller, respectively.

18. The system of claim 16, wherein the first transceiver and second transceiver each include a light source and a light sensor.

19. The system of claim 18, wherein the light source is an LED.

20. The system of claim 18, wherein the light sensor is a photo-diode.
